(19) United States
(12) Patent Application Publication
(10) Pub. No.: US 2019/0195404 A1
(43) Pub. Date: Jun. 27, 2019

(54) Hybrid Fitting for Connecting to an End of a Pipe

(71) Applicant: Uponor Innovation AB, VIRSBO (SE)

(72) Inventors: Rainer DITTMAR, Schweinfurt (DE); Stephan Müller, Haßfurt (DE)

(21) Appl. No.: 16/324,238

(22) PCT Filed: Aug. 31, 2017
(86) PCT No.: PCT/EP2017/071893

§ 371 Date: Feb. 8, 2019

(30) Foreign Application Priority Data
Sep. 6, 2016 (DE) 10 2016 116 652.9

(51) Int. Cl. F16L 33/207; F16L 47/24

(52) U.S. Cl. CPC F16L 33/2075; F16L 47/24; F16L 33/2076

(57) ABSTRACT

A hybrid fitting for connecting to pipe end and having a metal base; a connection body for supporting the end of the pipe, the connection body being formed separate from the base body and being made from a plastic material, wherein the connection body has a axial end; the base body comprises an opening for accommodating the axial end; the axial end of the connection body being insertable into the opening such that a form-fitted connection to the base body is formed; a locking element is slid over the connection body to engage with the base body such that the locking element is mechanically locked in an axial direction with respect to the base body; and in the locked state the locking element engages with the inserted connection body such that the inserted connection body is mechanically locked in the axial direction with respect to the base body.

The invention relates to a hybrid fitting for connecting to an end of a pipe, wherein the fitting comprises a base body and a connection body for supporting the end of the pipe.

Fittings with a base body and connection body are known from the prior art. Typically, a pipe is slid over the connection body between a pressing sleeve surrounding an end of the pipe. After radially pressing the pressing sleeve the pipe is attached to the fitting such that a fluid may be transferred through the pipe and the connected fitting.

An object of the present invention is to provide a concept for a fitting which contributes to low production costs and to a reliable fluid-tightness.

According to an embodiment of the invention, a hybrid fitting for connecting to an end of a pipe is described. The fitting comprises a base body made from a metal material. The fitting comprises a connection body for supporting the end of the pipe, the connection body being formed separate from the base body and being made from a plastic material. The connection body has an axial end. The base body comprises an opening for accommodating the axial end. The axial end of the connection body is inserted into the opening such that a form-fitted connection to the base body is formed. A locking element is slid over the connection body to engage with the base body such that the locking element is mechanically locked in an axial direction with respect to the base body. Further, in the locked state, the locking element engages with the inserted connection body such that the inserted connection body is mechanically locked in the axial direction with respect to the base body.

By providing the locking element, which is formed as a part separate from the connection body and the base body, a sealing function and a mechanical, form-fitting locking function may be distributed to separate parts of the hybrid fitting. In other words, both said functions are not necessarily integral parts of the connection body itself. For example, the sealing function can be ensured via the form-fit connection between the connection body and the base body.

As an advantage, tolerances arising from production, i.e. manufacturing tolerances, can be compensated, for example if the mechanical locking and a mechanical form-fit sealing function are distributed over two separate parts of the fitting. In particular, due to the separation of the locking function from the connection body, there remains a degree of freedom after inserting the connection body form-fittingly into the base body. Thus the connection body can be locked after the form-fit insertion of the connection body and after a predetermined position of the connection body in the base body is ensured. For example, a fluid-tight sealing of the connection body can be ensured by the form-fit insertion of the connection body and the axial locking can be achieved independent from the insertion of the connection body.

Further, the locking element exemplarily may be made from a material different from the material of the base body and/or the connection body. This allows for using specially adapted materials for the respective functions and/or for special uses or fitting applications. For example, the connection body may comprise a material enabling a high fluid-tightness and is adapted for a pipe to be attached to. For example, the locking element may be made from a material being adapted to guarantee a mechanically safe and reliable axial locking of the connection body to the base body. For example, the choice of materials can be adapted considering a creep behavior of a plastic material.

Further, a high application safety can be realized. In general, the fitting allows for high flexibility and high modularity and can be easily adapted to different applications or uses.

Further, depending on the use and intended purpose of the fitting, single parts of the fitting can be replaced and be adapted according to individual requirements, e.g. with respect to the materials. Thus, it is not necessary to provide different, complete fittings. This contributes to the high modularity and flexibility of the fitting.

Further, the hybrid fitting with a metal and a plastic part has the advantage that, by attaching a pipe to a plastic connection body, reliable fluid-tightness and high durability are provided. Plastic materials, i.e. synthetic or semi-synthetic organic compounds such as organic polymers of high molecular mass, have many advantageous properties, such as low weight and high resistance to many chemicals. Moreover, relatively complex profiles used for form- or press-fit connections can easily be manufactured using plastic molding. On the other hand, metal materials, such as stainless steel and brass, also have advantageous properties, such as their longevity and high stability. Moreover, parts of a fitting, such as threads, can easily be cut using conventional metal working techniques. Further, the fitting has high corrosion resistance and a good Zeta-Value. Further, leakages can be avoided due to the thermal expansions of the different materials. For example, the material of the connection body has a greater coefficient of thermal expansion than the material of the base body.

The base body may also be named base part. The connection body may also be named supporting body, onto which, at least over a connection section of the connection body, the end of a pipe can be slid. The supporting body supports the pipe in any subsequent pressing procedure, e.g. by pressing a pressing sleeve that surrounds the end of the pipe. The opening of the base body may be cylindrical. The connection body my be essentially cylindrical, at least with respect to the axial end being inserted into the base body and to the connection section for the pipe.

In the inserted state of the connection body, the hybrid fitting has a fluid passage being formed in the connection body and the base body such that a fluid, typically water, may pass through the fitting. The base body exemplarily may have a first cavity formed inside the same for carrying fluids. The connection body exemplarily may have a second cavity formed inside the same for carrying fluids. In the inserted state of the connection body, the fluid passage of the fitting comprises the first and second cavities. Typically, the fitting is connected to the end of a pipe. Alternatively, the fitting may also be connected to other fittins, fitting or pipe adapters, valves or actuators.

The axial end of the connection body is associated with the opening of the base body and provides a form-fit connection to the base body in the inserted state. For example, the connection body has a first contact surface and the base body has a second contact surface, which contact each other in the inserted state of the connection body for establishing the form-fit connection. In other words, the contact surfaces can be inserted one into the other and are implemented as cylinders, for example. The contact surface of the base body is formed by a part of the inner side of the wall of the base body, while the contact surface of the connection body is formed by a part of an outer surface of the adapter piece in the vicinity of the axial end. Thus, the base body surrounds at least partially the connection body. Thus, the metal material is outside, wherein the material of the connection body is at least partially arranged within the base body.

The locking element is slid over the connection body. In other words, the locking element has an inner opening to be surroundingly arranged over the connection body.

The hybrid fitting is assembled by firstly inserting the connection body into the base body in a form-fitting manner and by secondly sliding the locking element over the connection body to engage with the base body in the described locking manner, wherein the locking element axially locks the connection body to the fitting. In the mounted state, a fluid-tight connection is exemplary provided by the form-fit connection of the connection body to the base body, wherein the locking element ensures a permanent, inseparable conjunction. The connection between the base body and the connection body may be done by laser modification of respective contact surfaces for the form-fit connection.

In an embodiment of the hybrid fitting, the axial end of the connection body is press-fitted into the opening of the base body to form a fluid-tight connection between the base body and the connection body. Thus, a safe fluid-tight, e.g. watertight, and leak-proof connection is provided without any further sealing elements. In particular, the press-fit creates a surface compression, e.g. by the contact of the first and second contact surfaces as defined above. Thus, the press-fit results in the sealing between the base body and the connection body. The press-fit connection means a force-fit connection. Exemplarily, the axial end of the connection body is connected in an oversized manner to the base body. In other words, in the vicinity of the axial end the connection body has the first contact surface, e.g. a shell surface, which has a greater diameter than the second contact surface of the opening of the base body. Thus, no further sealing elements are necessary, thereby reducing production costs. Further, a standard assembly process is possible without the need for any further equipment, e.g. working tools.

In an embodiment, the locking element is a locking ring. In other words the locking element is at least ring-shaped or cylindrical. Thus, a simple locking element is provided, which allows for easy handling and mounting of the fitting.

In an embodiment, the locking element is slotted, in particular a slotted ring. In other words, the locking element is a snap ring (in German: Sprengring), which simplifies an assembly process of the fitting. For example, the snap ring enables a snap-in-connection. In other words, the ring can be clicked into the base body to be axially locked itself and to axially lock the inserted connection body.

In an embodiment, the locking element comprises an at least partially circumferential projection, which in the locked state of the locking element engages with a corresponding inner recess of the base body. Thus, a mechanical safe connection to the base body is provided. For example, the circumferential projection is disc-shaped. Exemplarily, the circumferential projection runs around a whole circumference of the locking element.

In an embodiment, the at least partially circumferential projection comprises an inclined surface at a peripheral surface of the projection. In particular, the peripheral surface is tapered such that an outer diameter decreases in a direction towards the base body. Thus, the assembling of the fitting is simplified. Further, the snap-in connection is supported or facilitated.

In an embodiment, the base body comprises an undercut, in particular defining the recess, and the locking element engages with the base body via the undercut by means of a snap-in connection. The undercut is a wall or wall section of the base body, which defines the recess. In particular, the undercut is arranged at a side facing an axial end of the base body, into which the connection body is inserted, e.g. at a front end of the fitting. The undercut may also be called a margin and extends inwardly, in particular towards a central longitudinal axis of the fitting. The locking is brought about by the engagement of the locking element with the undercut. This contributes to an easy and simple assembling of the fitting.

In an embodiment, the connection body comprises an at least partially circumferential projection, which comprises a first abutting face, wherein the first abutting face engages with a second abutting face of the base body in the inserted state of the connection body. Thus the locking function is achieved. An abutting face is a surface which runs in a radial direction with respect to a central longitudinal axis of the fitting. In other words, the radial direction runs orthogonal to a main fluid flow direction. As indicated above, the circumferential projection of the connection body may be disc-shaped. Exemplarily, the circumferential projection runs around the whole circumference of the connection body.

In an embodiment, the circumferential projection of the connection body is axially locked between the second abutting face of the base body and the locking element. Exemplarily, the connection body comprises a further, e.g. third, abutting face, which is arranged opposite the first abutting face, wherein the further abutting face engages with a respective abutting face of the locking element. In other words, the circumferential projection of the connection body is mechanically arranged between the base body and the locking element in an axially locking manner.

In an embodiment, the material of the connection body is in compliance with potable water regulations and the locking element is made from a further material different from the material of the connection body, such that a fluid flowing through the fitting, in particular potable water, is separated from the further material. For example, the locking element is made from metal or a further plastic material. In other words, the fluid passing the fitting cannot come into contact with the further material. For example, the material of the connection body, e.g. plastic material like PSU or PPSU, complies with regulations for drinking water, in particular Council Directive 98/83/EC of 3 Nov. 1998 of the European Union on the quality of water intended for human consumption. The material may additionally or alternatively comply with the German Drinking Water by-law (TrinkwV 2001). The material may additionally or alternatively comply with the Guidelines for Hygienic Assessment of Organic Materials in Contact with Drinking Water (KTW-Leitlinie W270) of the German Federal Environmental Bureau (Umweltbundesamt) in accordance with European Standard DIN EN 16421. Thus, as indicated above, the materials can fulfil different tasks and requirements. For example, the locking element can be made of the further material that guarantees the locking feature, e.g. fulfilling strength requirements, but that does not necessarily need to be in compliance with potable water regulations. Thus, the further material can have a higher strength. Optionally, the further material may comprise one or more reinforcement elements, e.g. fibres like glass-fibres or carbon fibres.

In an embodiment, the further material of the locking element comprises a greater stiffness than the plastic material of the connection body. Thus, the locking function is safely provided.

In an embodiment, the locking element comprises a means for connection in order that a pressing sleeve, which is slid over the connection body, can be axially locked to the locking element, e.g. a means for a snap-in-connection.

In an embodiment, the connection body is formed as a nipple for connecting a pipe or hose to the hybrid fitting. For example, the nipple comprises essentially an even wall-thickness.

In an embodiment, the plastic material of the connection body comprises a greater coefficient of thermal expansion than the metal material of the base body. The components are arranged in a way (plastic inside, metal outside) for which their thermal properties are suitable and increase the surface pressure at the contact surfaces of the base body and the connection body when it comes to a change in temperature, e.g. due to a differing temperature of the fluid passing the fitting.

In an embodiment, the connection body comprises a connection section having a plurality of annular recesses and/or protrusions and wherein the fitting has pressing sleeve, wherein the pressing sleeve is arranged on the fitting such that a pipe can be arranged between the connection section and the pressing sleeve. Thus, a pipe attached to the fitting surrounds the connection body and the section, wherein the pressing sleeve surrounds the pipe. Thus a press fitting is formed.

In a embodiment, the connection body comprises a connection section having a plurality of annular recesses and/or protrusions and wherein the fitting is designed for a quick connection technique or a quick connection procedure. Thus, the connection body is suitable for quick connect procedures, e.g. for what is known as the Quick & Easy Connection System of the firm Uponor. In such installation, an end of pipe is widened, in particular pipe of PE-Xa material (cross linked polyethylene), and subsequently slid over the connection body shrunk to the connection body. Due to a memory effect of the pipe material, the pipe sealingly engages with the connection body.

Further advantageous embodiments are disclosed in the following detailed description of an exemplary embodiment.

The exemplary embodiment of the invention is described below with reference to the attached figures. In the figures, similar components of different exemplary embodiments are denoted with the same reference signs.

In the figures:

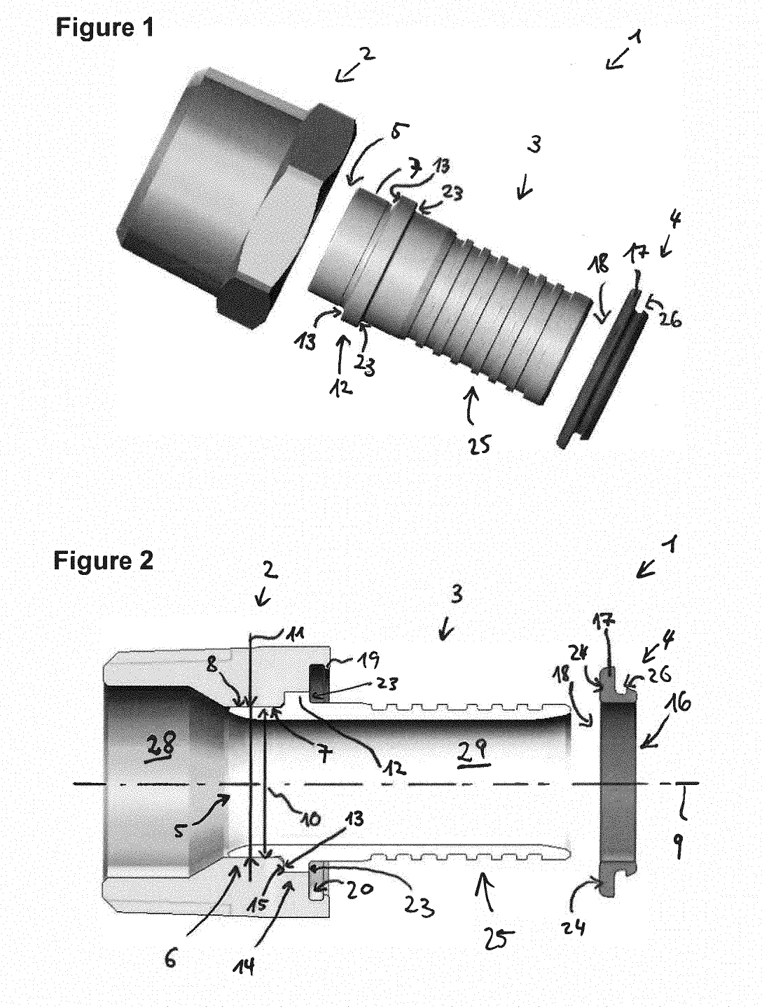

FIG. 1 shows an exploded view of a hybrid fitting with a locking element according to an embodiment of the invention;

FIG. 2 shows a schematical, sectional view of the fitting during assembly of the fitting;

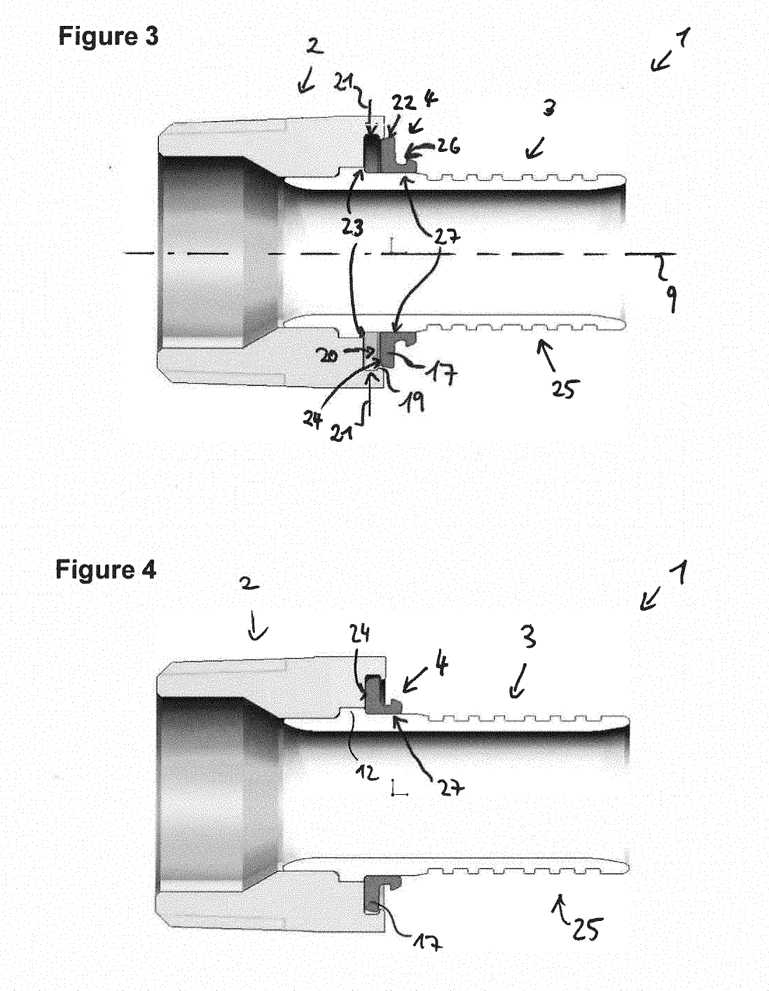

FIG. 3 shows a further schematical, sectional view of the fitting during assembly of the fitting;

FIG. 4 shows a schematical, sectional view of the fitting in an assembled state of the fitting;

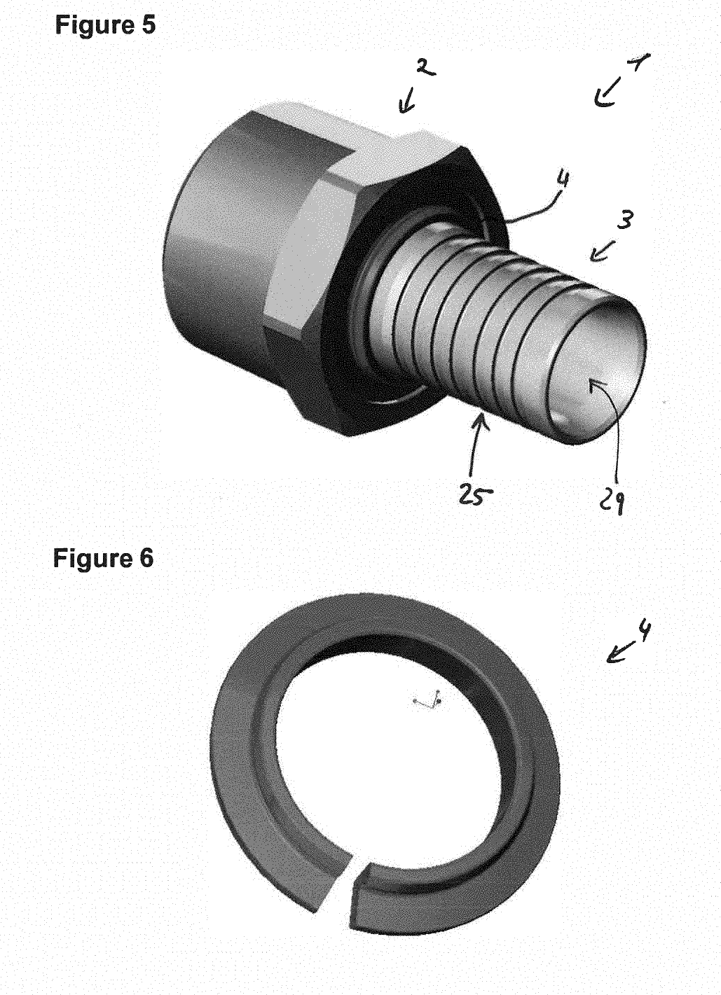

FIG. 5 shows a perspective view of the fitting in the assembled state; and

FIG. 6 shows a locking element for the fitting according to a further embodiment.

FIG. 1 shows an exploded view of a hybrid fitting 1 according to an embodiment of the invention. Hybrid means that the fitting 1 is composed of different, separate parts and not manufactured as one piece made from one single material.

The hybrid fitting 1 comprises a base body 2, which is made from metal. The base body 2 is formed such as to accommodate a connection body 3, which in the embodiment is a supporting body. The connection body 3 forms a nipple and thus is designed for a pipe to be attached to. The connection body 3 is made from a first plastic material. The fitting 1 further comprises a locking element 4, which is made from a second plastic material. The base body 2 may be made from brass material oder stainless steel, which ist in compliance with the drinking water directives or regulations. The connection body 3 may be made from a polysulfon material, e.g. PPSU or PSU. This first plastic material is in compliance with the regulations mentioned above. The locking element 4 is made from polyamide with a fibre reinforcement. An exemplary material is PA6.6 GF30. Alternatively, the locking element 4 may be made from polysulfon materials as well.

The fitting 1 can be assembled such that the connection body 3 is safely and fluid-tightly connected to the base body 2, as will be explained in the following.

With respect to FIG. 2, which shows a sectional view of the fitting 1 in a first assembling step, the connection body 3 comprises a first axial end 5, which is formed to be inserted into a first opening 6 of the base body 2. At the first axial end 5, the connection body 3 comprises a cylindrical, outer first contact surface 7, which is press-fitted into the first opening 6 of the base body 2. For the press-fit, the base body 2 comprises a corresponding second contact surface 8, which defines the first opening 6. In other words, with respect to a central longitudinal axis 9 of the fitting 1 (or at least of the base body 2) the first contact surface 7 has a first diameter 10, which is slightly larger than a second diameter 11 of the first opening 6. The press-fit creates a surface compression such that a sealing between the base body 2 and the connection body 3 is caused. In other words, by the press-fit a fluid-tight connection between said two components is formed. However, this press fit connection may not result in a sufficient holding force in a pull-out direction.

The connection body 3 comprises a disc-shaped first projection 12 extending outwards from the connection body 3. The first projection 12 can also be named flange ring. The first projection 12 is arranged adjacent to the first axial end 5, in particular adjacent to the first contact surface 7. The first projection 12 of the connection body 3 has a first abutting face (surface) 13, which runs orthogonal to the central longitudinal axis 9, or—in other words—runs in a radial direction with respect to the central longitudinal axis 9.

The first projection 12 of the connection body 3 is adapted to be form-fitted into a second opening 14 of the base body 2. The second opening 14 is adjacent to the first opening 6 an has a larger diameter than the first opening. The form-fit connection is similar to the connection as described above, not necessarily causing a fluid-tight or press-fit connection.

In the inserted state, the connection body 3 abuts with the first abutting face 14 on a second abutting face 15 of the base body 2. The second abutting face 15 defines a transition of an inner wall defining the first opening 6 of the base body 2 to the second opening 14.

In the first assembling step as described above, the connection body 3 can still be pulled out of the base body 2. In other words, the connection body 3 is not fully axially locked with respect to the base body 2, one degree of freedom still remains. In general, the axial direction is parallel to the central longitudinal axis 9 of the fitting 1. Rather, the connection body 3 axially abuts against the second abutting face 15 such that the connection body 3 cannot be inserted even further into the base body 2.

With regard to FIG. 2, both the connection body 3 and the base body 2 comprise cavities 28, 29 formed inside said bodies, respectively for carrying fluids like water. In the inserted state, the fitting 1 comprises a fluid passage, which comprises the first and the second cavities 28, 29.

In a subsequent second assembling step the locking element 4 is mounted (see FIGS. 3 and 4).

The locking element 4 is a locking ring and comprises a central ring opening 16, which is adapted to be slid over the connection body 3 (see FIG. 3). The locking element 4 can also be called locking clip.

The locking element 4 comprises a disc-shaped second projection 17 at an axial end 18 facing the base body 2. The second projection 17 can also be named second flange ring.

When sliding the locking element 4 towards the base body 2 over the connection body 3, the locking element 4 abuts against an undercut 19 of the base body 3. The undercut 19 is a wall section of the base body 3, defining a recess 20 within the base body 2. In other words, the undercut 19 is a wall section extending inwardly in a radial direction, i.e. towards the central longitudinal axis 9. The recess 20 is formed circumferentially within the base body adjacent to the second opening 14. An inner diameter 21 of the recess 20 is larger than the first and second diameters 10 and 11 as described above. The recess 20 is formed as a groove.

As can be seen from FIG. 4, the locking element 4 is subsequently pressed further against the base body 2, until the locking element 4 snap-fits into the recess 20 via the second projection 17. Thus, the second projection 17 is form-fittingly accommodated in the recess 20, wherein the undercut 19 prevents the locking element 4 from being axially moved. In this locked state the locking element 4 engages with the base body 2 such that an axial movement of the locking element 4 is blocked.

Furthermore, in the locked state the locking element 4 axially locks the connection body 3 to the base body 2. In this regard, the first projection 12 of the connection body 3 comprises a third abutting face 23, which is arranged opposite the first abutting face 13. The locking element 4 comprises a fourth abutting face 24. In the locked state, the fourth abutting face 24 engages with the third abutting face 13. Thus, the first projection 12 is arranged between the second abutting face 15 of the base body 2 and the fourth abutting face 24 of the locking element 4 such that the connection body 3 is axially locked to the base body 2.

FIG. 5 shows the assembled hybrid fitting 1 in a perspective view.

As can be seen from FIGS. 1 to 4, the second projection 17 of the locking element 4 comprises an outer inclined surface 22, wherein its outer diameter decreases towards the base body 2. Thus, the assembly is simplified.

In the embodiment of FIGS. 1 to 5, the locking element 4 is arranged on a further contact surface 27 of the connection body 3, at least in the locked and assembled state. The further contact surface is cylindrical with respect to the axis 9. Optionally, at least in the locked state, the locking element 4 may be arranged press-fittingly on the connection body 3, e.g. on the further contact surface 27.

As can be further seen in FIGS. 1 to 5, the locking element 4 comprises connection means 26, formed exemplarily as a recess and an undercut as explained above, which is adapted for a pressing sleeve to be arranged on the fitting 1. Then, in the assembled state, a pipe can be attached to the fitting by sliding an end of the pipe over the connection body 3, the pipe being surrounded by the pressing sleeve. In a subsequent pressing procedure, the pressing sleeve is pressed radially to establish a fluid-tight connection between the pipe and the connection body 3. As shown in FIGS. 1 to 5, in this regard the connection body 3 comprises a connection section 25 having a plurality of annular recesses and/or protrusions.

As indicated above, the connection body 3 and the locking element 4 are made from different plastic materials. Thus, the materials can be adapted to different requirements. In particular, the first plastic material of the connection body 3 is in compliance with potable water regulations. The second plastic material exhibits a greater stiffness than the first plastic material. Thus, for example the mechanical locking function can be ensured.

The assembled fitting 1 enables the functions and advantages as indicated above. In particular, a sealing function and the press-fit locking function are separated to different components of the fitting 1. Thus, the press-fit of the connection body 3 to the base body 2 is essentially not influenced by the locking element 4.

FIG. 6 shows a further embodiment of a locking element 4, which mainly differs from the locking element according to FIGS. 1 to 5 in that the locking element 4 of FIG. 6 is slotted. The slotted locking element 4 may be radially pressed together to simplify the assembling process. When inserted in the recess, the slotted locking element 4 may expand due to elastic forces to ensure the locking as indicated above.

### LIST OF REFERENCE SIGNS

1 hybrid fitting
2 base body
3 connection body
4 locking element
5 first axial end
6 first opening
7 first contact surface
8 second contact surface
9 central longitudinal axis
10 first diameter
11 second diameter
12 first projection
13 first abutting face
14 second opening
15 second abutting face
16 ring opening
17 second projection
18 axial end
19 undercut
20 recess
21 inner diameter
22 inclined surface
23 third abutting face
24 fourth abutting face
25 connection section
26 connection means
27 further contact surface
28 first cavity
29 second cavity

1. A hybrid fitting for connecting to an end of a pipe, the hybrid fitting comprising;
a base body made from a metal material;
a connection body to support the end of the pipe, the connection body being formed separate from the base body and being made from a plastic material, wherein
the connection body has an axial end;
the base body comprising an opening for accommodating the axial end;
the axial end of the connection body being insertable into the opening such that a form-fitted connection to the base body is formed;
a locking element being slidable over the connection body to engage with the base body such that the locking element is mechanically locked in an axial direction with respect to the base body; and
in the locked state the locking element being engageable with the inserted connection body such that the inserted connection body is mechanically locked in the axial direction with respect to the base body.

2. The hybrid fitting according to claim 1, wherein the axial end of the connection body is press-fitted into the opening of the base body to form a fluid tight connection between the base body and the connection body.

3. The hybrid fitting according to claim 1, wherein the locking element is a locking ring.

4. The hybrid fitting according to claim 1, wherein the locking element is a slotted ring.

5. The hybrid fitting according to claim 1, wherein the locking element comprises an at least partially circumferential projection, which in the locked state of the locking element engages with a corresponding inner recess of the base body.

6. The hybrid fitting according to claim 5, wherein the at least partially circumferential projection comprises an inclined surface at a peripheral surface of the projection.

7. The hybrid fitting according to claim 1, wherein the base body comprises an undercut defining a recess, and the locking element being engageable with the base body via the undercut by a snap-in connection.

8. The hybrid fitting according to claim 1, wherein the connection body comprises an at least partially circumferential projection, which comprises a first abutting face, wherein the first abutting face engages with a second abutting face of the base body in the inserted state of the connection body.

9. The hybrid fitting according to claim 8, wherein the circumferential projection of the connection body is axially locked between the second abutting face of the base body and the locking element.

10. The hybrid fitting according to claim 1, wherein the material of the connection body is in compliance with potable water regulations and the locking element is made from a further material, in particular a further plastic material, different from the material of the connection body, such that a fluid flowing through the fitting, in particular potable water, is separated from the further plastic material.

11. The hybrid fitting according to claim 10, wherein the further material of the locking element comprises a greater stiffness than the plastic material of the connection body.

12. The hybrid fitting according to claim 1, wherein the locking element comprises a means for connection in order that a pressing sleeve, which is slidable over the connection body, can be axially locked to the locking element.

13. The hybrid fitting according to claim 1, wherein the connection body is formed as a nipple for connecting a pipe or hose to the hybrid fitting.

14. The hybrid fitting according to claim 1, wherein the plastic material of the connection body comprises a greater coefficient of thermal expansion than the metal material of the base body.

15. The hybrid fitting according to claim 1, wherein the connection body comprises a connection section having a plurality of annular recesses and/or protrusions and wherein the fitting has a pressing sleeve, wherein the pressing sleeve is arranged on the fitting such that a pipe can be arranged between the connection section and the pressing sleeve.

16. The hybrid fitting according to claim 1, wherein the connection body comprises a connection section having a plurality of annular recesses and/or protrusions and wherein the fitting is designed for a quick connection technique or a quick connection procedure.
